(19) United States
(12) Patent Application Publication
(10) Pub. No.: US 2001/0011405 A1
(43) Pub. Date: Aug. 9, 2001

(54) Hinge

(76) Inventor: Saburo Minami, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 09/757,656

(22) Filed: Jan. 11, 2001

(30) Foreign Application Priority Data
Jan. 11, 2000 (JP) 2000-2443
Apr. 12, 2000 (JP) 2000-110526
Dec. 15, 2000 (JP) 2000-381605

(51) Int. Cl. E05D 7/10

(52) U.S. Cl. 16/229

(57) ABSTRACT

The objective of the present invention is to provide a hinge giving a neat look to the mounting area of a door without being exposed to the outer surface of the door, the hinge being composed of a hinge spindle unit, buried flush with the top and bottom lines on the fixed end of the door and disposed in a way to allow protrusion and retraction of the spindle, and a hinge body unit, buried at a position facing the hinge spindle unit of the open frame and in which is inserted the protruding spindle, and supporting the door in a way to open and close.

### BACKGROUND OF THE INVENTION

The present invention concerns a hinge, more specifically a hinge giving a neat look to the mounting area of a door without being exposed to the outer surface of the door, facilitating mounting and removal of the door and enabling the door to be opened and closed either inward or outward.

Conventionally, a door mounted at the entrance of a house or a room is provided with a hinge between the open frame and the door to enable opening and closing of the door.

This hinge normally consists of 2 hinge elements fit to each other by means of a single shaft in a way to open and close, these hinge elements being fixed to the open frame and the door respectively by screwing.

By the way, said conventional hinge used to be made of such materials as stainless steel, brass, aluminium alloy, etc. and was provided with coating or plating on the outer surface, as required, and also with various kinds of design in some cases.

However, how neatly and gorgeously it may be manufactured, a hinge, which is mounted between the open frame and the door by screwing and in a place visible from outside the door, could not maintain a neat look for the mounting area of the door, and also presented a problem of troublesome work of tightening and loosening set screws for mounting and removing the door.

Moreover, a conventional hinge, which is mounted by being set in advance to open and close the door either inward or outward, also had a problem of inconvenience of use, because the direction of opening and closing of the door cannot be changed after the door is once installed, even in the case where the room would be used more conveniently if the direction of opening and closing of the door is changed after a change in the arrangement of furniture, etc. in the room.

### SUMMARY OF THE INVENTION

The objective of the present invention, realized in light of the said problems of conventional types of hinges, is to provide a hinge that gives a neat look to the mounting area of a door without being exposed to the outer surface of the door, facilitating mounting and removal of the door and enabling the door to be opened and closed either inward or outward.

To achieve said objective, the hinge according to the present invention is characterized in that it is comprised of a hinge spindle unit, buried flush with the top and bottom lines on the fixed end of the door and disposed in a way to allow protrusion and retraction of the spindle, and a hinge body unit, buried at a position facing the hinge spindle unit of the open frame and in which is inserted the protruding spindle, and supporting the door in a way it can both open and close.

According to the hinge of the present invention, which is designed to support the door in a way to both open and close it as the protruding and retracting spindle of a hinge spindle unit, buried flush with the top and bottom lines on the fixed end of the door, is inserted in the hinge body unit buried at a position facing the hinge spindle unit of the open frame, it becomes possible to give a neat look to the door mounting area without exposing the hinge to the outer surface of the door, and allow the door to be opened and closed either inward or outward.

Plus, this hinge makes it possible to mount or remove the door in and from the open frame with just protruding and retracting operation of the spindle, without tightening or loosening set screws as with conventional hinges, and thus facilitated mounting and removal of the door.

In this case, the hinge spindle unit can be comprised of a spindle case body, a spindle inserted in the spindle case body in a way to be locked and protrude and retract under the urging force of a spring, and a stopper holding the spindle in a state retracted in the spindle case body.

This makes it possible to not only easily bury the hinge spindle unit in the door, but to also facilitate mounting and removal of the door in and from the open frame, by holding the spindle in a state retracted in the spindle case body with a stopper.

Moreover, the hinge spindle unit can be comprised of a spindle case body, a spindle inserted in the spindle case body in a way to be locked and forming a rack gear biting with a pinion disposed in the spindle case body and capable of protruding and retracting by turning said pinion, and a stopper holding the spindle in prescribed position.

This makes it possible to not only easily bury the hinge spindle unit in the door, but to also facilitate protrusion and retraction of the spindle, facilitate mounting and removal of the door in and from the open frame, and stably mount the door in the open frame.

Furthermore, the hinge body unit can be comprised of a hinge body provided with a boss in which to insert a spindle, and a cam slidably supported in the hinge body and retracting the spindle.

This makes it possible to not only easily bury the hinge body unit in the open frame, but also facilitate quick mounting and removal of the door in and from the open frame.

Still more, the hinge body unit can be comprised of a hinge body buried and fixed at a position facing the hinge spindle unit of the open frame, and a slide base, disposed slidably against the hinge body and forming a spindle insertion hole in a way to be fixed at any desired position on the hinge body.

This makes it possible to easily adjust the position of the spindle insertion hole and mount the door accurately in the open frame.

### BRIEF DESCRIPTION OF THE DRAWINGS

FIG. 1 is an explanatory drawing showing a door and an open frame to which is applied the hinge according to the present invention, (A) being a front elevation, and (B) a transverse sectional plan view.

FIG. 2 is a front elevation showing the first embodiment of the hinge according to the present invention.

FIG. 3 is an explanatory drawing of actions for above.

FIG. 4 indicates the spindle case body, (A) being a front elevation, (B) a sectional view, and (C) a sectional view at line C-C.

FIG. 5 indicates the spindle, (A) being a front elevation, and (B) a bottom view.

FIG. 6 indicates the stopper, (A) being a front elevation, and (B) a bottom view.

FIG. 7 is an explanatory drawing of actions of the cam in the hinge body unit.

FIG. 8 indicates the hinge body, (A) being a plan view, (B) a front elevation, and (C) a bottom view.

FIG. 9 indicates the cam, (A) being a plan view, (B) a side view.

FIG. 10 is a sectional view showing the door and the open frame.

FIG. 11 is a front elevation showing the second embodiment of the hinge according to the present invention.

FIG. 12 indicates the hinge spindle unit, (A) being a sectional view, (B) a front elevation, (C) a plan view, and (D) a bottom view.

FIG. 13 indicates the first modified example of the hinge spindle unit in the second embodiment of the present invention, (A) being a sectional view, (B) a front elevation, (C) a plan view, and (D) a bottom view.

FIG. 14 indicates the second modified example of the hinge spindle unit in the second embodiment of the present invention, (A) being a sectional view, (B) a front elevation, (C) a plan view, and (D) a bottom view.

FIG. 15 indicates the third modified example of the hinge spindle unit in the second embodiment of the present invention, (A) being a sectional view, (B) a front elevation, and (C) a bottom view.

FIG. 16 indicates the spindle case body, (A) being a front elevation, (B) a sectional view, and (C) a bottom view.

FIG. 17 indicates the spindle, (A) being a front elevation of the spindle body element, (B) a bottom view, (C) a sectional view of the rack gear element, and (D) a bottom view.

FIG. 18 indicates the pinion, (A) being a side view, and (B) a sectional view.

FIG. 19 is a sectional view showing the entire part of this third modified example.

FIG. 20 indicates the fourth modified example of the hinge spindle unit.

FIG. 21 indicates the first modified example of the hinge body unit in the second embodiment of the present invention, (A) being a plan view, (B) a front elevation, and (C) a sectional view.

FIG. 22 indicates the hinge body, (A) being a plan view, (B) a sectional view, and (C) a bottom view.

FIG. 23 indicates the slide base, (A) being a plan view, (B) a sectional view, and (C) a bottom view.

FIG. 24 is a sectional view showing the second modified example of the hinge body unit in the second embodiment of the present invention.

FIG. 25 indicates the hinge body, (A) being a plan view, (B) a sectional view, and (C) a bottom view.

FIG. 26 indicates the body cover, (A) being a plan view, (B) a sectional view, and (C) a bottom view.

FIG. 27 indicates the slide base, (A) being a plan view, (B) a sectional view, and (C) a bottom view.

FIG. 28 indicates the adjusting cam, (A) being a plan view, (B) a front elevation, and (C) a bottom view.

FIG. 29 indicates the metal, (A) being a plan view, and (B) a front elevation.

FIG. 30 indicates a metal of simple construction used for the present invention, (A) being a partially broken front elevation, and (B) a plan view.

### DETAILED DESCRIPTION OF THE INVENTION

Embodiments of the hinge according to the present invention will be explained based on drawings hereafter.

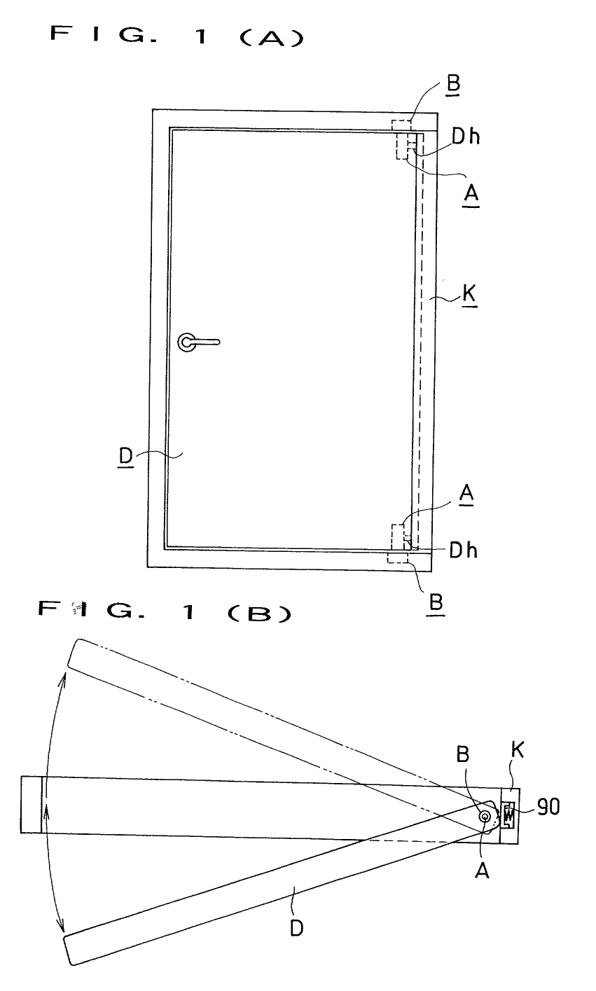

FIG. 1 to FIG. 10 indicate the first embodiments of the hinge according to the present invention.

This hinge comprises a hinge spindle unit A, buried flush with the top and bottom lines on the fixed end of the door D and disposed in a way to allow protrusion and retraction of the spindle 2, and a hinge body unit B, buried at a position facing the hinge spindle unit A of the open frame K and supporting the door D in a way to open and close as the protruding spindle 2 is inserted in the hinge body unit B.

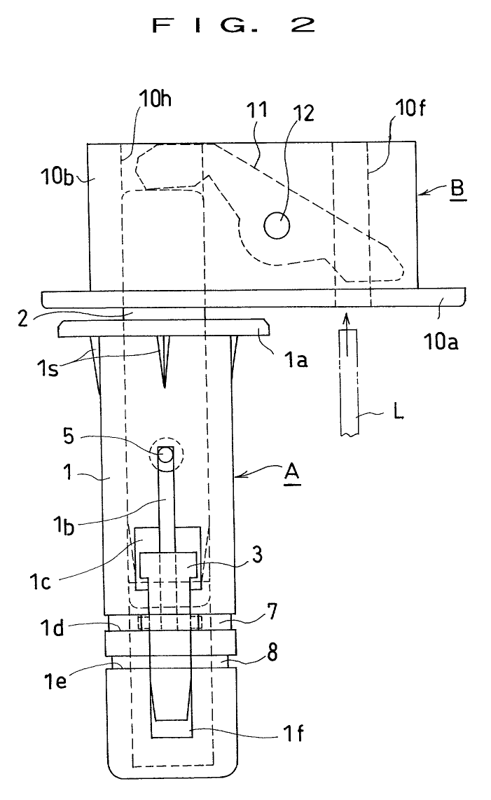

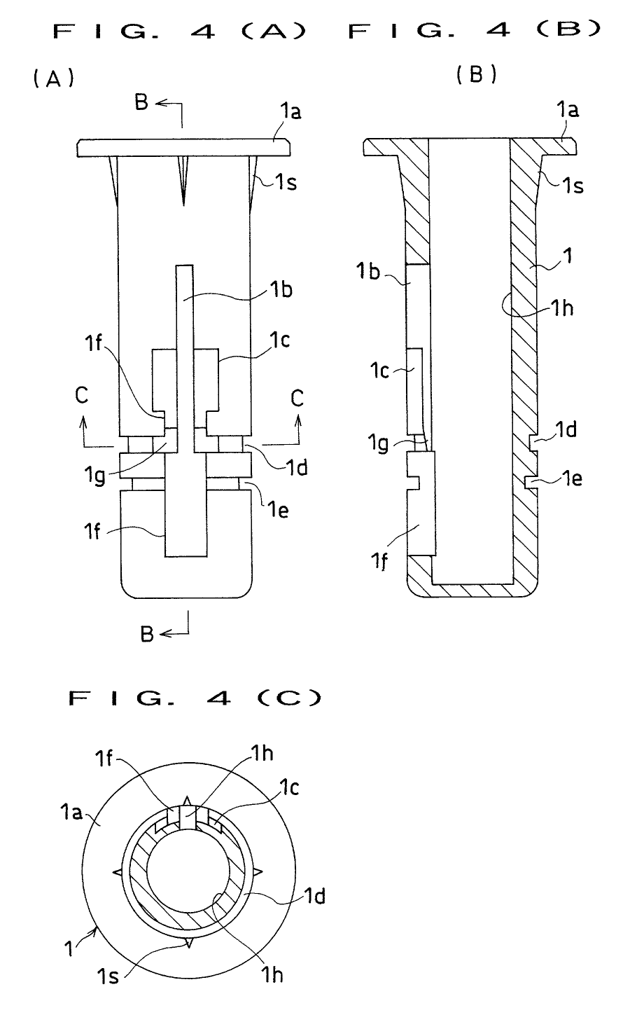

The hinge spindle unit A buried flush with the top and bottom lines on the fixed end of the door D is provided with a spindle case body 1 formed in a cylindrical shape, forming two ring grooves 1d, 1e on the outer circumferential face and having a hole 1h in which to insert the spindle 2 inside, as shown in FIG. 2 and FIG. 4.

These two ring grooves 1d, 1e are formed at positions where the stopper 3 inserted from the shallow groove 1c to the hole 1f does not get away from the spindle case body 1 even if it swings in the shape of a seesaw.

And, at the outer circumference on the opening end side of the spindle case body 1 is integrally formed a mounting flange 1a, and on the surface of the spindle case body 1 is formed, along the longitudinal direction of the spindle case body 1, a guide groove 1b regulating the sliding range of the spindle 2.

Moreover, along the guide groove 1b is formed, at its lower position, a shallow groove 1c and a hole 1f in which to insert the stopper 3, and in the connecting area between the inner bottom part of the shallow groove 1c and the hole 1f is formed a sloped face 1g.

Furthermore, at the outer circumference of the spindle case body 1 is formed a fastening claw is in proximity to the mounting flange 1a, so that the spindle case body 1 may be fixed in a way not to turn, in the state buried in the hinge mounting hole H formed at the top and the bottom on the fixed end of the door D.

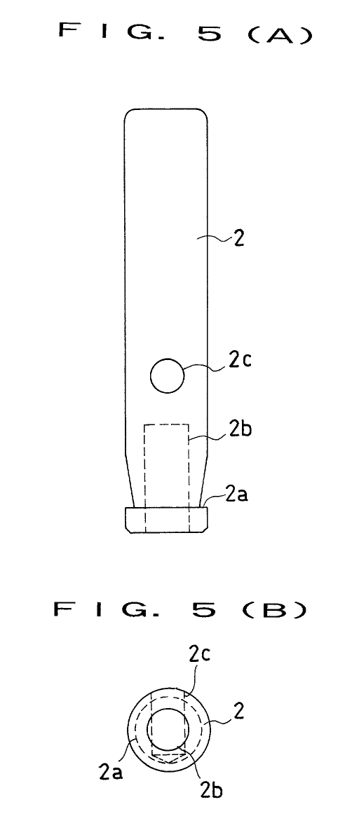

The spindle 2 to be inserted in the hole 1h in the spindle case body 1 has a length and a diameter sufficient for supporting the door D in a way to open and close, forms at its bottom end a fastening claw 2a in stepped shape so that it may be fastened by the tip of the stopper 3, forms inside the bottom end a spring insertion hole 2b, and forms on its outer circumferential face a guide insertion hole 2c in the direction orthogonal to the shaft center of the spindle 2, as shown in FIG. 5.

This spindle 2 will have an outside diameter to be inserted, without play and in a way to protrude and retract, in the hole 1h in the spindle case body 1 in the allowable range of tolerance, and be formed in such a way that the tip of the spindle 2 may be inserted, at the time of protrusion, in the hinge body unit B to support the door D in a way to open and close.

Still more, since the spindle 2 is urged by a spring 4 inserted in the inner bottom of the hole 1h in the spindle case body 1, a guide 5 will be inserted in the guide insertion hole 2c so that the spindle 2 may not get out of the spindle case body 1 because of this urging force.

This guide 5 will be inserted in the guide insertion hole 2c through a spring 6 so that the small-diameter portion 5a at the tip of the guide 5 may constantly protrude under the urging force of the spring 6, and the small-diameter portion 5a at the tip of this guide 5 will be inserted in the guide groove 1b, to thereby prevent the guide 5 from getting out of the spindle 2 and prevent the spindle 2 from getting out of the spindle case body 1.

Yet more, a stopper 3 will be provided on the spindle case body 1.

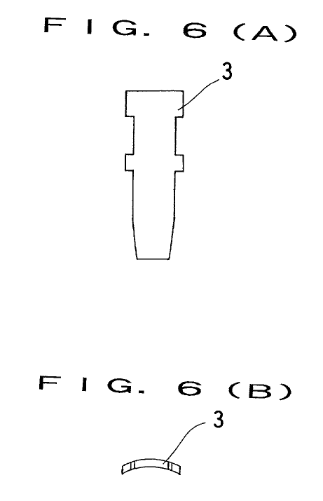

The stopper 3 will be formed with a thin metallic element in a way to be slightly curved, so that the spindle 2 may have a concave face, as shown in FIG. 6.

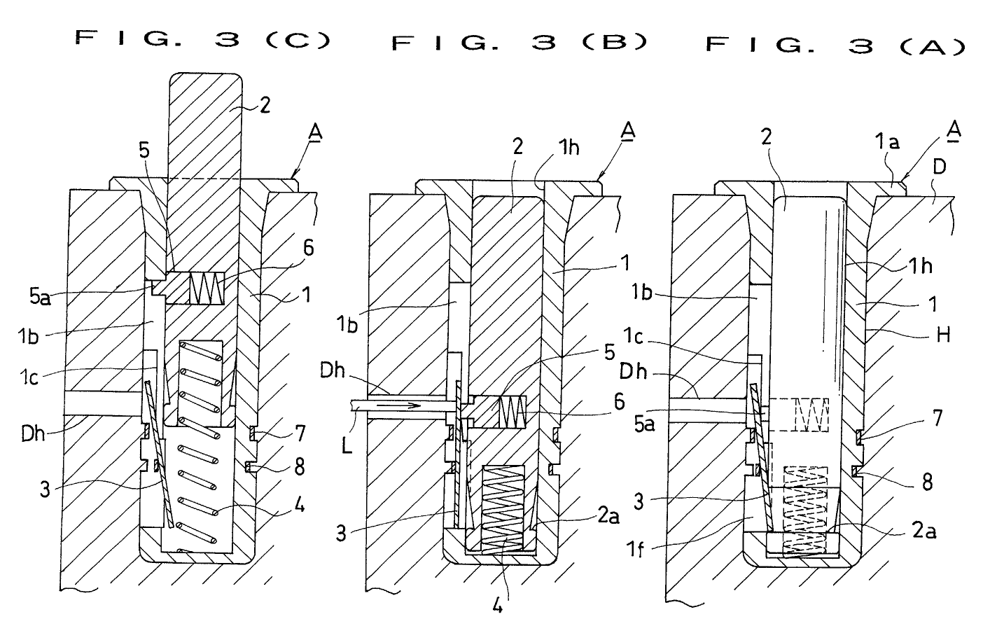

This stopper 3 will be inserted from the shallow groove 1c to the hole If of the spindle case body 1, and will be supported in the shape of a seesaw and slidably and in a slightly inclined position, as shown in FIG. 3 (C), normally, by means of stopper rings 7, 8 made of spring steel fit in the ring grooves 1d, 1e so that it may not get away from the spindle case body 1.

In this case, the swing angle of the stopper 3 is controlled by a slope face 1g formed at the inner bottom of the shallow hole 1c in the spindle case body 1.

The swing angle of this stopper 3 and its positional relation in the spindle case body 1 are stipulated in such a way that the fastening claw 2a of the spindle 2 is fastened by the tip of the stopper 3, in the state in which the spindle 2 is completely retracted in the hole 1h in the spindle case body 1, as shown in FIG. 3 (A).

Moreover, the outer face at fixed end of the stopper 3 will be constructed in such a way that the stopper 3 swings to release the fastening between the tip of the stopper 3 and the fastening claw 2a, as this outer face is pushed by an operating rod L inserted through the insertion hole Dh formed at the end face of the door D, as shown in FIG. 3 (B).

On the other hand, the hinge body unit B buried at a position facing the hinge spindle unit A of the open frame K is provided with a hinge body 10 buried in the open frame K, and a cam 11 swingably supported by a shaft 12 in this hinge body 10, as shown in FIG. 2 and FIG. 7 to FIG. 9.

The hinge body 10 integrally forms, on the back face side of the mounting collar 10a fixed to the open frame K, a barrel 10b buried in the open frame K in a smaller size compared with the mounting collar 10a.

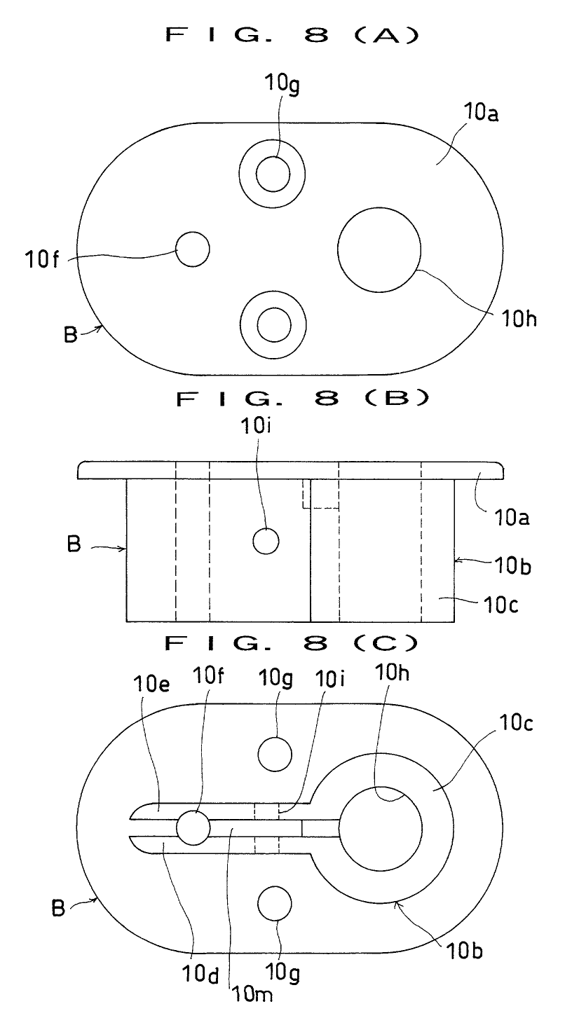

This barrel 10b is formed, as shown in FIG. 8 (B), (C), with a boss 10c having a hole 10h in which to insert the spindle 2 at an end, and cam supporting elements 10d, 10e, disposed on the outer circumferential face of this boss 10c in a way to mutually face by forming a groove 10m, and forms a shaft hole 10i in these cam supporting elements 10d, 10e.

The width of this groove 10m is determined in such a way that the cam 11 may swing with a shaft 12 inserted through the shaft hole 10i, and a cam push hole 10f is formed in a way to pass through the mounting collar 10a at the edge position of the groove 10m.

This cam push hole 10f and the hole 10h in the boss 10c are formed in such a way that their centers are positioned on the longitudinal shaft center of the groove 10m.

10g is a set screw hole formed in the mounting collar 10a.

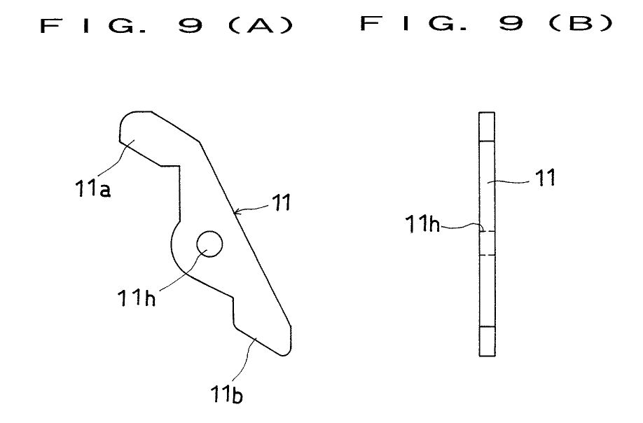

The cam 11 has a flat shape, as shown in FIG. 9, and is swingably supported on the hinge body 10 with the shaft 12 inserted through the shaft hole 11h formed at about the center, and is formed into a spindle pushing element 11 a for pressing the head of the spindle 2 at an end and into a rod pushing element 1b to be pressed by the operating rod L at the other end.

Next, the assembling method and actions of this hinge will be explained.

Bury and fix the stopper 3 at the outer circumference of the spindle case body 1, and the hinge spindle unit A, in which is inserted the spindle 2, through a spring 4 in a way to be locked with a guide 5, on one same line at the top and the bottom on the fixed end side of the door D respectively.

In this case, by pushing the spindle 2 into the spindle case body 1 against the urging force of the spring 4, the fastening claw 2a of the spindle is fastened by the tip of the stopper 3, and the spindle 2 is kept in the state retracted in the spindle case body 1.

In addition, bury the hinge body unit B, on which is swingably disposed the cam 11, in the open frame K, at a position where the spindle insertion hole 10h faces the spindle 2 of the hinge spindle unit A buried in the door D.

Next, to mount the door D in the open frame K, install the door D at prescribed position of the open frame K, insert the operating rod L in the rod insertion hole Dh formed at the end face of the door D, by adjusting the position of the spindle insertion hole 10h of the hinge body unit B to that of the spindle 2 of the hinge spindle unit A, and make the stopper 3 swing by pushing the outer side face on fixed end of the stopper 3 with the tip of the operating rod L, to release the fastening with the fastening claw 2a of the spindle 2.

This makes it possible for the spindle 2 to protrude from the spindle case body 1 with the urging force of the spring 4. Since the small-diameter shaft portion 5a of the guide 5 inserted in the spindle 2 is inserted in the guide groove 1b, the spindle 2 stops and is prevented from getting out when this small-diameter shaft portion 5a of the guide 5 gets in contact with the end position of the guide groove 1b.

And, the head of the spindle 2 protruding from the spindle case body 1 is inserted in the spindle insertion hole 10h on the hinge body unit B side.

In this way, by making the spindles 2, 2 of the respective spindle units A provided at the top and bottom of the door D protrude, it becomes possible to mount the door D in the open frame K in a way to open and close on the spindles 2, 2.

At that time, if the head of the spindle 2 is inserted in the spindle insertion hole 10h, with a protrusion of the spindle 2, by approximately 10 mm to 30 mm for example, the spindle pushing element 11a of the cam 11 positioned on the spindle insertion hole 10h is pushed up by the head of the spindle 2, as shown in FIG. 2.

As a result, the cam 11 swings around the shaft 12, and the rod pushing element 10b on the opposite side is held in the pushed down state.

On the other hand, to remove the door D from the open frame K, expose the cam pushing hole 10f of the hinge body unit B buried in the open frame K by keeping the door D in open state, insert the operating rod L in this cam pushing hole 10f, and push the rod pushing element 11b of the cam 11 to make the rod pushing element 11b of the cam 11 go up.

As a result, the cam 11 swings around the shaft 12, and the head of the spindle 2 is pushed down, through the spindle pushing element 11a on the opposite side.

In this way, as the spindle 2 is pushed into the spindle case body 1 against the urging force of the spring 4, the fastening claw 2a is fastened by the tip of the stopper 3, and the spindle 2 is kept in the state retracted in the spindle case body 1.

As a result, the spindle 2 is held in the spindle case body 1 in retracted state, and unfastened from the hinge body unit B buried in the open frame K.

By making this operation for both of the hinge spindle units A, A buried at the top and the bottom on the fixed end side of the door D, it becomes possible to remove the door D from the open frame K.

In the above case, the operating sequence of the hinge spindle units A, A buried at the top and the bottom on the fixed end side of the door D is not particularly restricted, and can be made from either the top or the bottom side.

By the way, in the case where the door D is mounted in a way to open and close on the spindles 2, 2, it is necessary to form the surface on the fixed end side of the door D in sloped shape and form a prescribed gap between the surface on the fixed end side of the door D and the open frame K, to ensure smooth opening and closing of the door D.

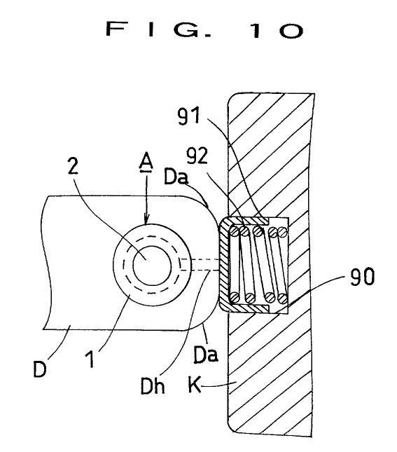

To meet these requirements, it is possible to perform chamfering Da on the surface on the fixed end side of the door D and adopt a construction of disposing a door pad 91 in a way to protrude and retract under the urging force of a spring 92 in the concave part 90 formed on the open frame K, as shown in FIG. 10, to thereby avoid producing a gap between the surface on the fixed end side of the door D and the open frame K.

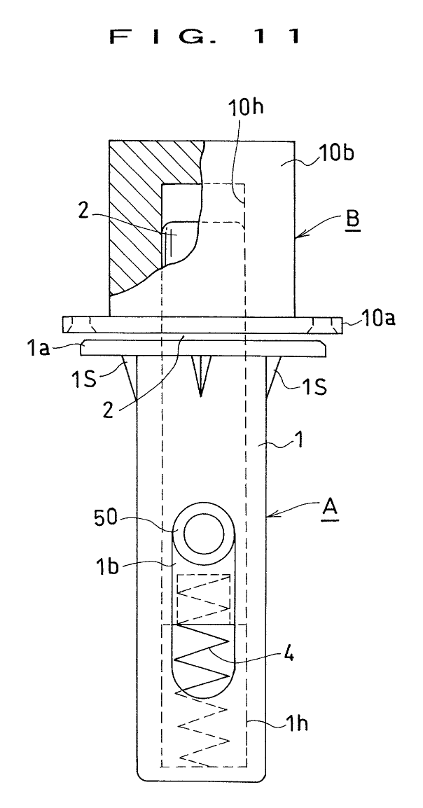

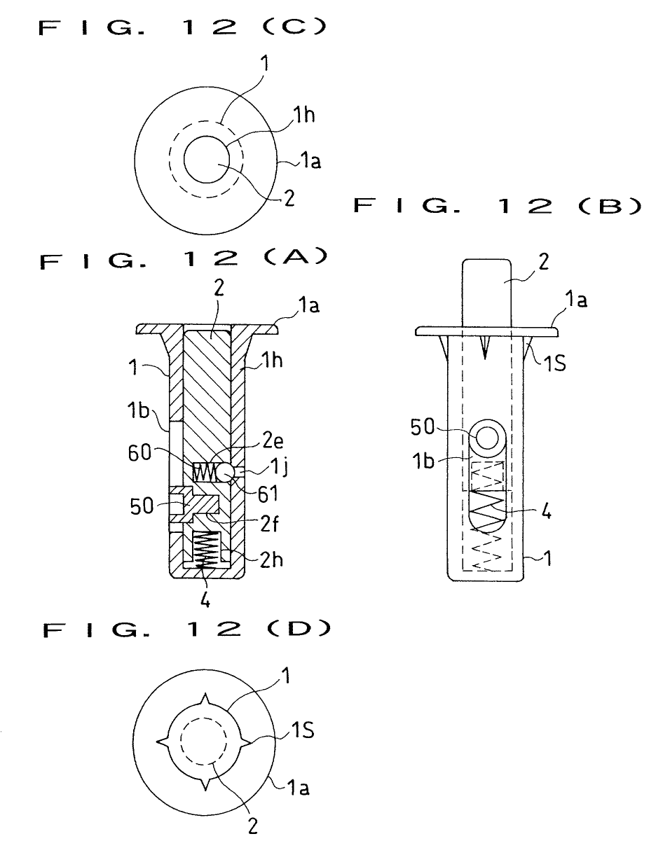

FIG. 11 and FIG. 12 indicate the second embodiment of the hinge according to the present invention.

This hinge is constructed, as the hinge of said first embodiment, with a hinge spindle unit A, buried flush with the top and bottom lines on the fixed end side of the door D and disposed in a way to allow protrusion and retraction of the spindle 2, and a hinge body unit B, buried at a position facing the hinge spindle unit A of the open frame K and supporting the door D in a way to open and close as the protruding spindle 2 is inserted in the hinge body unit B.

In this case, the hinge spindle unit A buried flush with the top and bottom lines on the fixed end of the door D is provided with a spindle case body 1, formed in a cylindrical shape having a hole 1h in which to insert the spindle 2 inside, and a spindle 2.

And, at the outer circumference on the opening end side of the spindle case body 1 is integrally formed a mounting flange 1a, and on the surface of the spindle case body 1 is formed, along the longitudinal direction of the spindle case body 1, a guide groove 1b in which to insert an operating element 50 for regulating the sliding range i.e. range of protrusion and retraction of the spindle 2.

Moreover, at the outer circumference of the spindle case body 1 is formed a fastening claw is in proximity to the mounting flange 1a, so that the spindle case body 1 may be fixed in a way not to turn, in the state buried in the hinge mounting hole H formed at the top and the bottom on the fixed end of the door D.

The spindle 2 has a length and a diameter sufficient for supporting the door D in a way to open and close, forms inside the bottom end a spring insertion hole 2h, and forms on its outer circumferential face a stopper ball insertion hole 2e and an operating element insertion hole 2f in the direction orthogonal to the shaft center of the spindle 2.

This spindle 2 will have an outside diameter to be inserted, without play and in a way to protrude and retract, in the hole 1h in the spindle case body 1 in the allowable range of tolerance, and be formed in such a way that the tip of the spindle 2 may be inserted, at the time of protrusion, in the hinge body unit B to support the door D in a way to open and close.

Furthermore, since the spindle 2 is urged by a spring 4 inserted in the inner bottom of the hole 1h in the spindle case body 1 and the spring insertion hole 2h, an operating element 50 will be inserted in the guide insertion hole 2c provided in projection from the spindle 2 so that the spindle 2 may not get out of the spindle case body 1 because of this urging force.

This operating element 50 will be formed in small diameter at the fixed end to be inserted by either forced fitting or screw fastening in the operating element insertion hole 2f of the spindle 2, and in large diameter with a hole in which to insert the operating at the tip, and the large-diameter portion will be inserted in the guide groove 1b, to thereby prevent the spindle 2 from getting out of the spindle case body 1 with the operating element 50.

In the stopper ball insertion hole 2e of the spindle 2 will be inserted a stopper ball 61 in a way to be urged by a spring 60, in the direction of pushing out the stopper ball 61 through the stopper ball insertion hole 2e.

And, in the spindle case body 1 will be formed a stopper hole 1j, as shown in FIG. 12 (A), so that the spindle 2 may be held in retracted state with a fitting of the stopper ball 61, when the spindle 2 is retracted in the spindle case body 1.

Still more, to make the spindle 2 protrude, from the state retracted and held in the spindle case body 1, and be inserted on the hinge body B side, the operating element 50 will be operated with the operating rod, in a way to draw out the spindle 2 and release the fitting of the stopper ball 61 in the stopper hole 1j.

This makes it possible for the tip of the spindle 2 to protrude from inside the spindle case body 1 with an action of the spring 4, as shown in FIG. 12 (B).

On the other hand, the hinge body B side, buried at a position facing the hinge spindle unit A of the open frame K, is provided with a hinge body 10 to be buried in the open frame K, as shown in FIG. 11.

The hinge body 10 will integrally form, on the back face of the mounting collar 10a to be fixed to the open frame K, a barrel portion 10b having a hole 10h in which to insert the spindle 2, to be buried in the open frame K, in smaller size compared with the mounting collar 10a.

The spindle insertion hole 10h may be formed, either with a bed or in a way to pass through the barrel portion 10b.

Next, the assembling method and actions of this hinge will be explained.

Insert the spring 60 and the stopper ball 61 in the stopper ball insertion hole 2e of the spindle 2, insert the spindle 2 in the hole 1h of the spindle case body 1 in which is inserted the spring 4, and bury and fix the hinge spindle unit A with the operating element 50 inserted in the guide groove 1b in projection, flush with the top and bottom lines on the fixed end side of the door D respectively.

In this case, by operating the operating element 50 and pushing the spindle 2 into the spindle case body 1 against the urging force of the spring 4, the stopper ball 61 is fit into the stopper hole 1j, and the spindle 2 is kept in the state retracted in the spindle case body 1.

In addition, bury the hinge body unit B, on which is swingably disposed the cam 11, in the open frame K, at a position where the spindle insertion hole 10h faces the spindle 2 of the hinge spindle unit A buried in the door D.

Next, to mount the door D in the open frame K, install the door D at prescribed position of the open frame K, adjust the position of the spindle insertion hole 10h in the hinge body unit B to that of the spindle 2 of the hinge spindle unit A, and, by operating the operating element 50 with the operating rod from the guide groove 1b formed on the end face of the door D, disengage the stopper ball 61 from the stopper hole 1j while drawing out the spindle 2.

As a result, the spindle 2 protrudes from the spindle case body 1 under the urging force of the spring 4. Since the operating element 50 disposed on the spindle 2 is inserted in the guide groove 1b, the spindle 2 stops and is prevented from getting out when this operating element 50 gets in contact with the end position of the guide groove 1b.

And, the head of the spindle 2 protruding from the spindle case body 1 is inserted in the spindle insertion hole 10h on the hinge body unit B side.

In this way, by making the spindles 2, 2 of the respective spindle units A provided at the top and the bottom of the door D protrude, it becomes possible to mount the door D in the open frame K in a way to open and close on the spindles 2, 2.

On the other hand, to remove the door D from the open frame K, expose the guide groove 1b formed at the end face of the door D by keeping the door D in open state. Insert the operating rod L in this slit-shaped guide groove 1b, and operate the operating element 50 with the operating rod and push the spindle 2 into the spindle case body 1 against the urging force of the spring 4, to fit the stopper ball 61 into the stopper hole 1j, and keep the spindle 2 in the state retracted in the spindle case body 1.

As a result, the spindle 2 is held in the spindle case body 1 in retracted state, and unfastened from the hinge body unit B buried in the open frame K.

By making this operation for both of the hinge spindle units A, A buried at the top and the bottom on the fixed end side of the door D, it becomes possible to remove the door D from the open frame K.

In the above case, the operating sequence of the hinge spindle units A, A buried at the top and the bottom on the fixed end side of the door D is not particularly restricted, and can be made from either the top or bottom side.

Other construction and actions of this embodiment are the same as those of the hinge of said first embodiment.

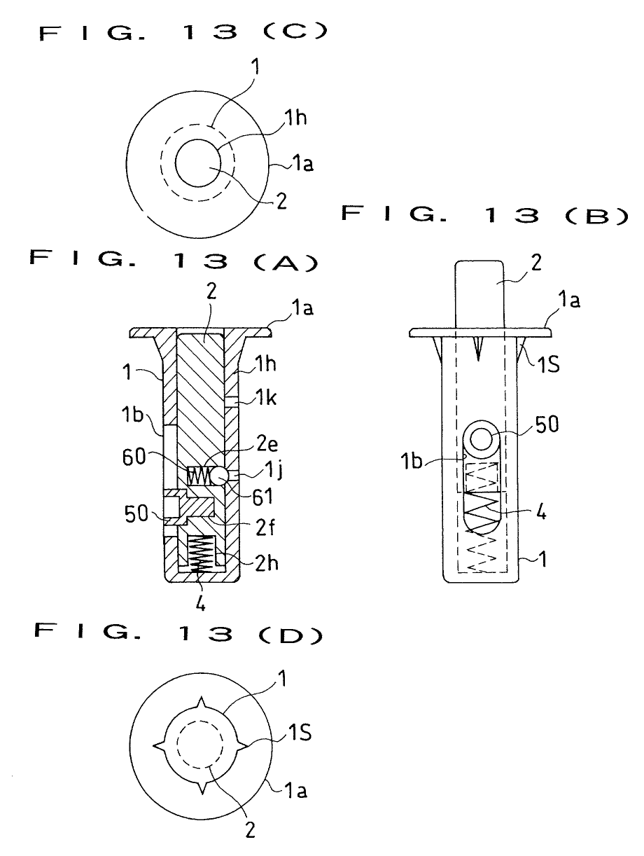

By the way, in the hinge of said second embodiment, a stopper hole 1k may be formed, as in the first modified example of hinge spindle unit in the second embodiment of the present invention indicated in FIG. 13, in such a way that the spindle 2 may be held in protruded state with a fitting of the stopper ball 61, when the tip of the spindle 2 protrudes from inside the spindle case body 1, so that the tip of the spindle 2 may be held securely in the state protruding from inside the spindle case body 1.

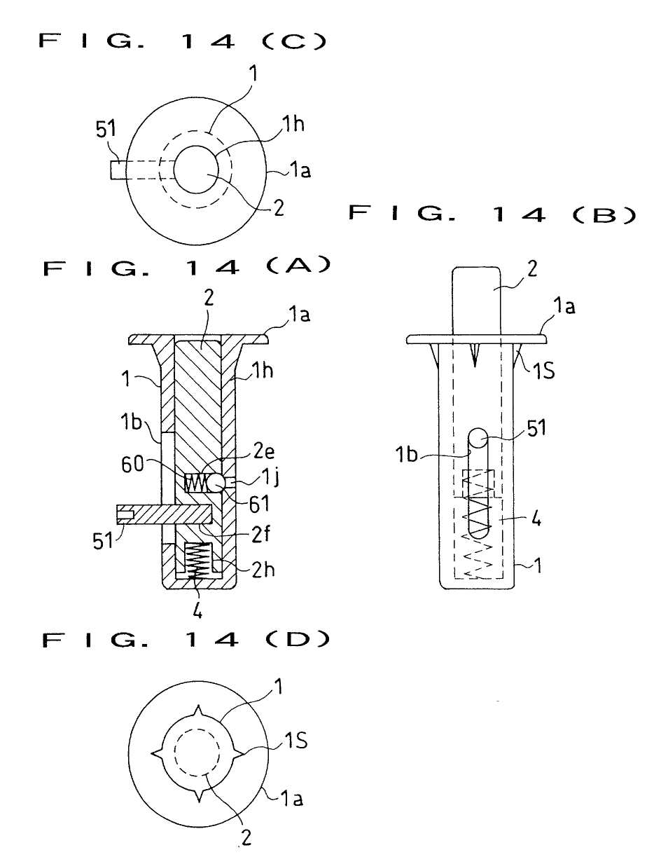

Moreover, the operating element of the spindle 2 may be formed in a way to be directly operated, by inserting the operating element 51 formed in the shape of a pin in the operating element insertion hole 2f of the spindle 2 and making the tip of the operating element 51 protrude from the spindle case body 1, as in the second modified example of hinge spindle unit in the second embodiment of the present invention indicated in FIG. 14.

Other construction and actions of those modified examples are the same as those of the hinge of said second embodiment.

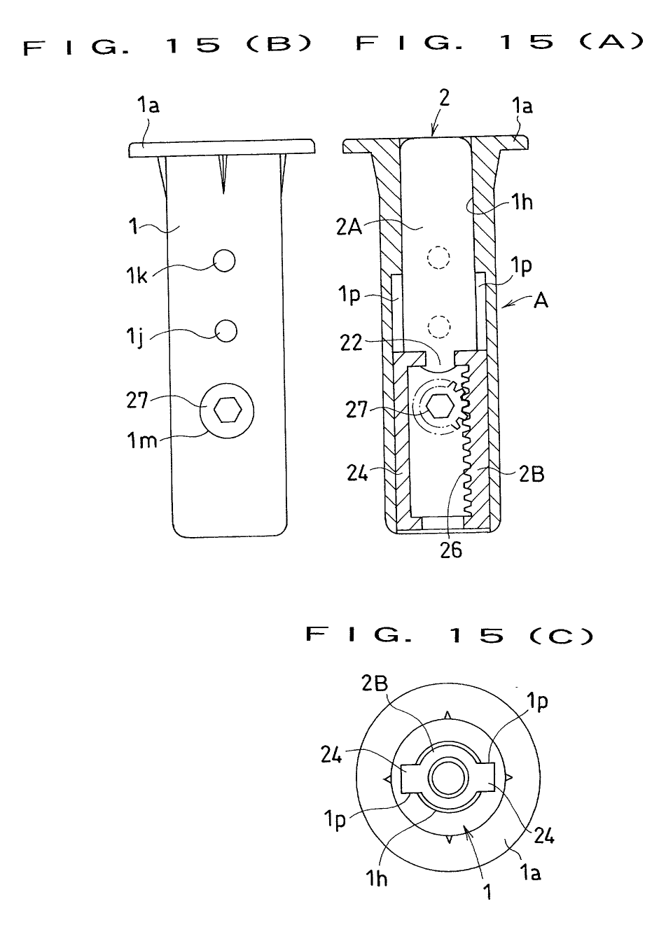

FIG. 15 to FIG. 19 indicate the third modified example of hinge spindle unit in the second embodiment of the present invention.

This hinge is constructed, in the same way as the hinge of said first embodiment and second embodiment, with a hinge spindle unit A, buried flush with the top and bottom lines on the fixed end side of the door D and disposed in a way to allow protrusion and retraction of the spindle 2, and a hinge body unit B, buried at a position facing the hinge spindle unit A of the open frame K and supporting the door D in a way to open and close as the protruding spindle 2 is inserted in the hinge body unit B.

In this case, the hinge spindle unit A buried flush with the top and bottom lines on the fixed end of the door D is provided with a spindle case body 1, formed in a cylindrical shape having a hole 1h in which to insert the spindle 2 inside, and a spindle 2.

And, on the spindle case body 1 will be disposed a pinion 27, and a rack gear 26 engaged with this pinion 27 will be formed on the spindle 2 and disposed in such a way that the spindle 2 may protrude from and be retracted into the spindle case body 1 with a turn of the pinion 27.

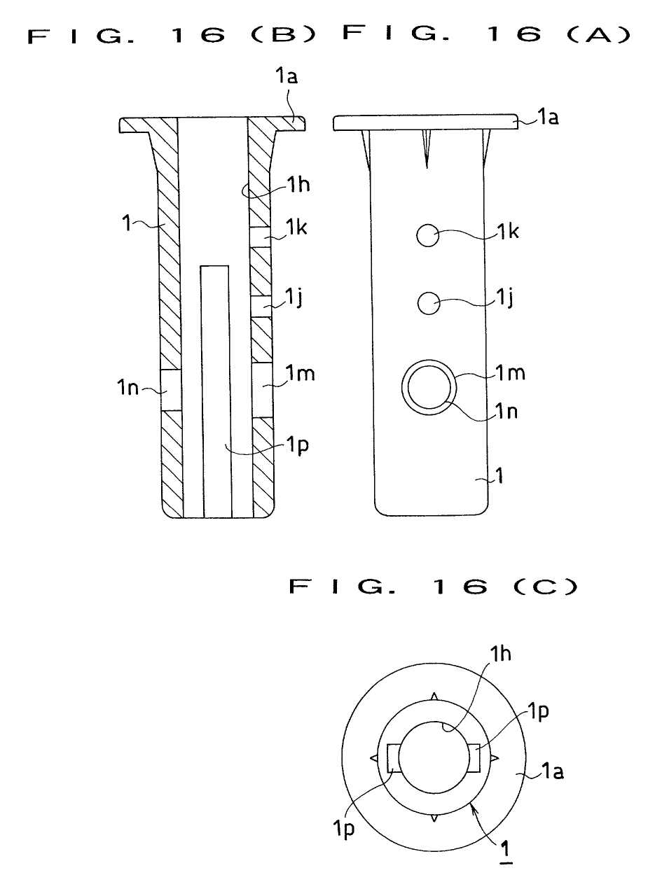

To be more concrete, the spindle case body 1 will form, as shown in FIG. 15 and FIG. 16, a hole 1h in which to insert the spindle 2 inside and a mounting flange 1a on the outer circumference of the opening.

And, a rack gear insertion groove 1p will be formed, along the longitudinal direction on the inner circumferential surface of the hole 1h in which to insert the spindle 2, and holes 1j, 1kin which to insert the stopper ball 61 to be described later will be formed at 2 points along the longitudinal direction of the spindle case body 1, while gear insertion holes 1m, 1n with different diameters will further be formed in a way to pass in transversal direction through the circumferential wall of the spindle case body 1, at a position close to this hole 1j.

The length and width of this rack gear insertion groove 1p are determined in such a way that the spindle 2 slides only in the longitudinal direction of the spindle case body 1 without turning.

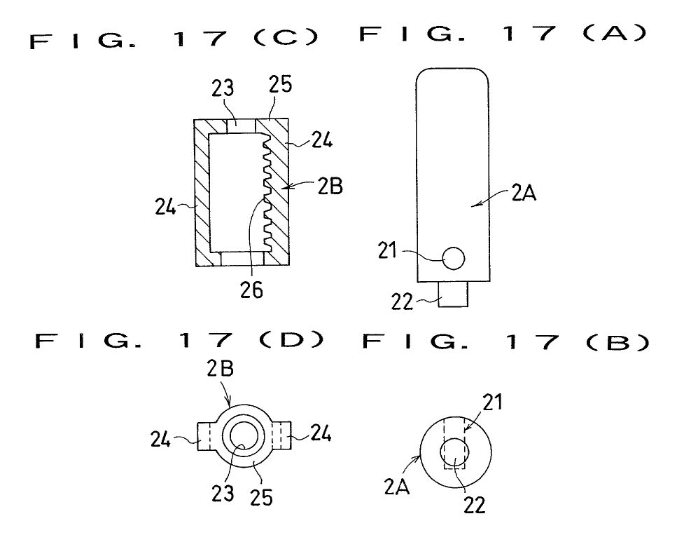

The spindle 2 will be composed of a bar-shaped spindle body element 2A and a rack gear element 2B forming a rack gear 26, as shown in FIG. 17, and its overall length will be set to be completely retracted in the spindle case body 1.

In the spindle body element 2A will be formed a stopper ball insertion hole 21, and in this stopper ball insertion hole 21 will be inserted a stopper ball 61 in a way to be urged in the direction of pushing out from the stopper ball insertion hole 21 by means of a spring 60.

In this case, the stopper ball insertion hole 21 will be formed in the direction agreeing with the holes 1j, 1k in the spindle case body 1.

And, it will be so arranged that the spindle 2 may be stably held selectively in either retracted or protruded state, as the stopper ball 61 fits in the holes 1j, 1k formed in the spindle case body 1.

Moreover, at the bottom of the spindle body element 2A will be provided a fastening element 22 of small diameter in projection, and this fastening element 22 will be inserted in the hole 23 formed in the rack gear element 2B and caulked at the tip, to integrate the spindle body element 2A and the rack gear element 2B.

The rack gear element 2B will have its side faces in longitudinal direction formed in side elements 24, 24 having a width fit for insertion in the rack gear insertion groove 1p, and form, in the end element for connecting the side elements 24, 24, a hole 23 for inserting the fastening element 22 provided in projection on the spindle body element 2A. In addition, on the inside of one side element 24 will be formed a rack gear 26, and the tip of the fastening element 22 inserted in the hole 23 will be caulked to integrate the rack gear 26 with the spindle body element 2A.

In this case, the orientation of the spindle body element 2A and the rack gear element 2B will be adjusted in such a way that the rack gear 26 may mutually bite with the pinion 27 inserted in the spindle case body 1.

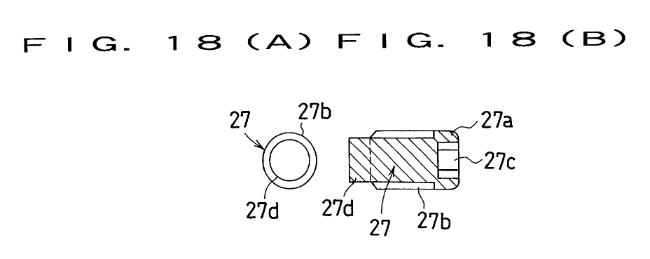

The pinion 27 will have a length about equal to the outside diameter of the spindle case body 1, and will be formed in an outside diameter to be supported in a hole 1m of large diameter formed in the spindle case body 1 at the fixed end 27a and in an outside diameter to be supported in a hole 1n of small diameter formed in the spindle case body 1 at the tip 27d, and a gear 27b will be serrated on the outer circumferential face at the intermediate area, as shown in FIG. 18.

Furthermore, on the end face of the fixed end 27a of the pinion 27 will be formed an operating hole 27c for turning the pinion 27 by means of a tool (not illustrated) such as hexagon wrench, etc. to be inserted from outside the door D.

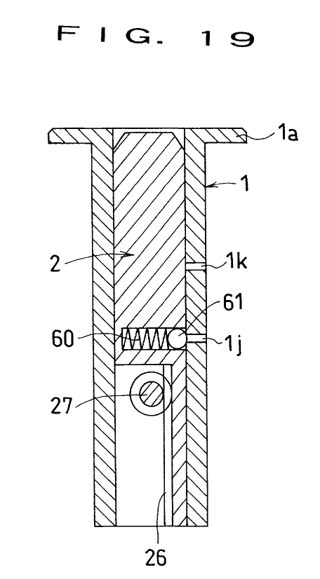

Although, in this embodiment, the spindle 2 is composed of a spindle body element 2A and a rack gear element 2B, the spindle 2 may also be composed of a single member, as in the modified example given in FIG. 19.

In this case, a space for inserting the pinion 27 will be formed at a lower part of the spindle 2, and a part of the side area of the spindle 2 will be notched, and on this notched face will be serrated the rack gear 26.

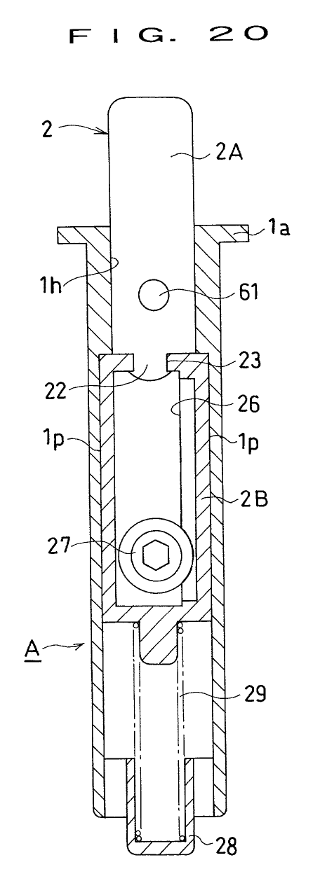

FIG. 20 indicates the fourth modified example of the hinge spindle unit in the second embodiment of the present invention.

The hinge spindle unit in this fourth modified example of the embodiment has the same form as that of the third modified example basically, but is different from the latter in that, while the protruding and retracting actions of the spindle 2 are performed by making the rack gear element 2B biting with it move up and down with a rotation of a pinion in the third modified example, the protruding action of the spindle 2 is made with the urging force of a spring 29 and the retracting action is performed by means of a pinion 27 and a rack gear element 2B in this fourth modified example.

And, in this fourth modified example, the hinge spindle unit is composed of a spindle case body 1 formed in the shape of a cylinder having a mounting flange 1a on the outer circumference of the opening, and a spindle 2 to be inserted in it in a way to protrude and retract, and constructed in a way to push and support the bottom end of the spindle 2 by means of a spring 29 supported by a spring fastening device 28 fastened to the spindle case body 1.

The spindle 2 integrates a bar-shaped spindle body element 2A and a rack gear element 2B having a rack gear 26 serrated on the inside by caulking a fastening element 22, in the same way as in the third modified example, and a pinion 27 rotatably supported in the spindle case body 1 passes through said rack gear element 2B and bites with the rack gear 26. And, it is so arranged that, when the rack gear 26 is turned by means of a tool such as hexagon wrench, etc. inserted in the hexagon hole of this rack gear 26, the spindle body element 2A is retracted into the spindle case body 1 against the spring pressure through the rack gear element 2B fit to the rack gear 26.

This spindle 2 is designed to move along the rack gear insertion hole 1p serrated on the inner face of the spindle case body 1, and constantly protrude from the spindle case body 1 with the elastic force of a spring 29 supporting the bottom part. And, to maintain the spindle 2 in the state retracted in the spindle case body 1 as shown in FIG. 15 (A), a ball 61 is inserted under a spring pressure in the spindle body element 2A in the same way as shown in FIG. 19, so that this ball 61 may fit the stopper hole 1j formed in the spindle case body 1 at the spindle retracting position.

Other basic construction and actions of this embodiment and its modified examples are the same as those of the hinge of said second embodiment, except for the difference in the mechanism for protruding and retracting the spindle 2.

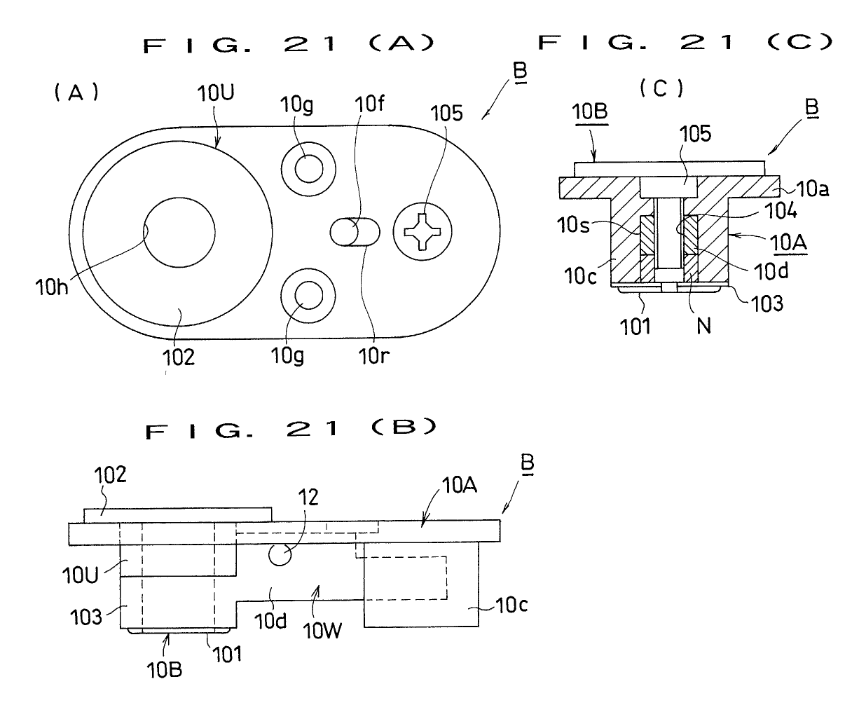

FIG. 21 to FIG. 23 indicate the first modified example of hinge body in the second embodiment of the present invention.

This hinge concerns, in the same way as the hinge of said first embodiment and second embodiment, the hinge body unit B to be buried flush with the top and bottom lines on the fixed end of the door D and used together with a hinge spindle unit A in which is disposed the spindle 2 in a way to protrude and retract, and it is buried at a position facing the hinge spindle unit A of the open frame K, and can adjust the position of the spindle insertion hole 10h in which to insert the protruding spindle 2 easily, to enable to mount the door D accurately in the open frame K.

In this case, the hinge body unit B is composed of a hinge body 10A, to be buried and fixed at a position facing the hinge spindle unit A of the open frame K, and a slide base 10B, disposed slidably against this hinge body 10A and forming a spindle insertion hole 10h in a way to be fixed at any desired position on the hinge body 10A.

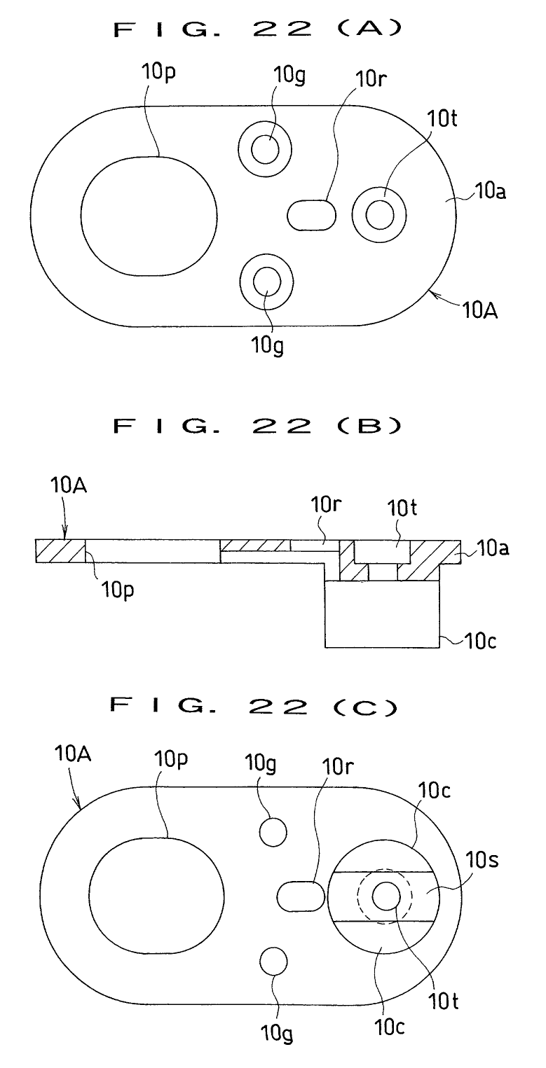

The hinge body 10A integrally forms, on the back face side of the mounting collar 10a buried in the open frame K and fixed by screwing, a barrel 10c, and forms set screw holes 10g, 10g, an adjusting hole 10r and a metal insertion hole 10p in the mounting collar 10a, as shown in FIG. 21 and FIG. 22.

This barrel 10c will form a slit groove 10s, open at the bottom face and unrotatably supporting a cam supporting element 10d and a nut N inserted there, and in this slit groove 10s will be formed a bolt insertion hole 10t in a way to be different in diameter at the top and at the bottom.

The metal insertion hole 10p, the adjusting hole 10r and the slit groove 10s will be formed on one same straight line.

Moreover, the metal insertion hole 10p and the adjusting hole 10r will be formed in the shape of a slit respectively, so that the slide base 10B may be moved for adjustment against the hinge body 10A.

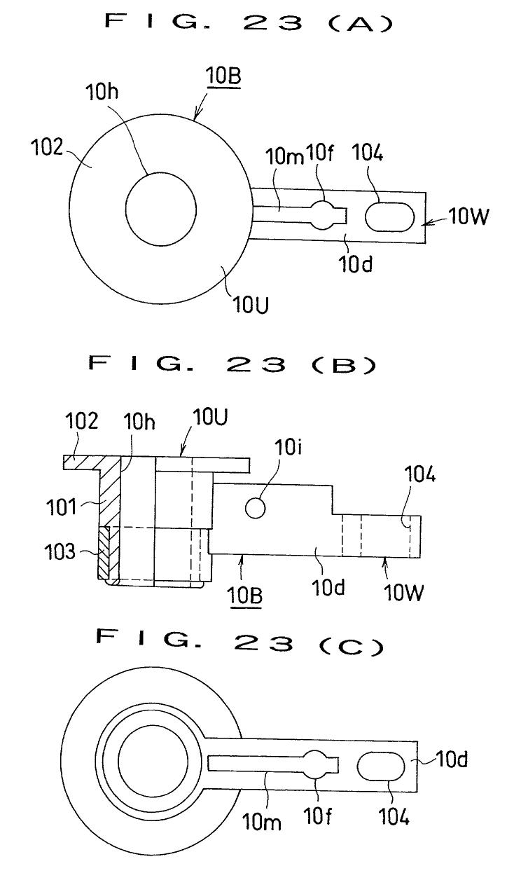

The slide base 10B is composed of a metal 10U in the shape of a short collared pipe, and a slider 10W, as shown in FIG. 21 and FIG. 23.

The metal 10U, which forms a spindle insertion hole 10h in the barrel 101 in the shape of a short pipe and integrally forms a collar 102 on the outer circumference at the edge, will be integrated with the slider 10W so that the barrel 101 may be inserted in the metal insertion hole 10p of the hinge body 10A in a way to be slidably adjusted in the longitudinal direction of the metal insertion hole 10p.

This slider 10W will integrally form a metal holder 103 in the shape of a short pipe at one end of the cam supporting element 10d, and the barrel 101 of the metal 10U will be inserted in the metal holder 103 and caulked at its end, to fix the metal 10U.

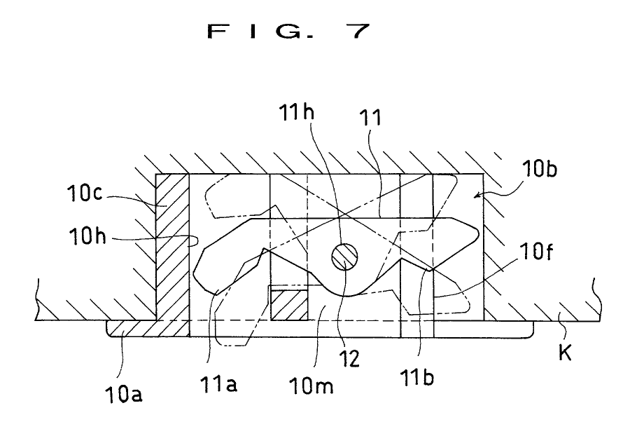

Furthermore, the cam supporting element 10d of the slider 10W, the width and length of which are determined in a way to be slidably inserted in the slit groove 10s, will form a groove 10m in which the cam 11 (see FIG. 7) is slidably inserted.

In the cam supporting element 10d having the groove 10m will be formed a shaft hole 10i for slidably supporting the cam 11, while a cam push hole 10f will be formed in part of the groove 10m.

Still more, in the cam supporting element 10d will be formed an adjusting set hole 104 in the shape of a slit, so that the slide base 10B may be fixed at any desired position of the hinge body 10A, as a fastening screw 105 inserted in the bolt insertion hole 10t passes through this adjusting set hole 104 and is engaged with the nut N.

To assemble the slide base 10B realized by fastening the metal 10U to the metal holder 103 of the slider 10W, and the hinge body 10A, attach the slider 10W from the back side of the hinge body 10A, fit the cam supporting element 10d in the slit groove 10s, insert the metal 10U from the surface side in the metal insertion hole 10p and the metal holder 103, and caulk the tip of the barrel 101 of the metal 10U, integrating the metal 10U with the slider 10W.

This makes it possible for the slide base 10B to slide in the metal insertion hole 10p in the shape of a slit, against the hinge body 10A.

And, by tightening the nut N, after adjusting the position of the spindle insertion hole 10h, and fixing the slide base 10B to the hinge body 10A, it becomes possible to mount the door D in the open frame K accurately.

Yet more, in the groove 10m of the slide base 10B is slidably mounted the cam 11 by means of a shaft 12 inserted in the shaft hole 10i, but its action is the same as that of the hinge of said first embodiment.

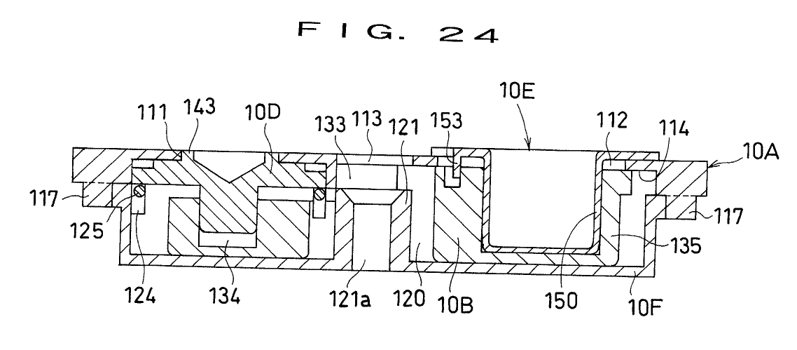

FIG. 24 to FIG. 29 indicate the second modified example of hinge body in the second embodiment of the present invention.

This second modified example of hinge body is buried, as shown in the second embodiment, at a position facing the hinge spindle unit A of the open frame K, and enables to adjust the position of the spindle insertion hole in which to insert the protruding spindle 2 easily, to thereby enable to mount the door D in the open frame K accurately and in a way to keep a uniform clearance at the outer circumference of the door D.

In this case, the hinge body unit B is composed of a hinge body 10A, to be buried in the open frame K, a body cover 10F, attached to the back side of this hinge body 10A and assembled in a way to be integrated with the hinge body 10A by caulking, etc., a slide base 10B, slidably inserted between the hinge body 10A and the body cover 10F and enabling adjustment of the spindle insertion hole position, a metal 10E inserted in the spindle insertion hole of the slide base 10B, an adjusting cam 10D for adjusting the movement of the slide base 10B, and a spring 125.

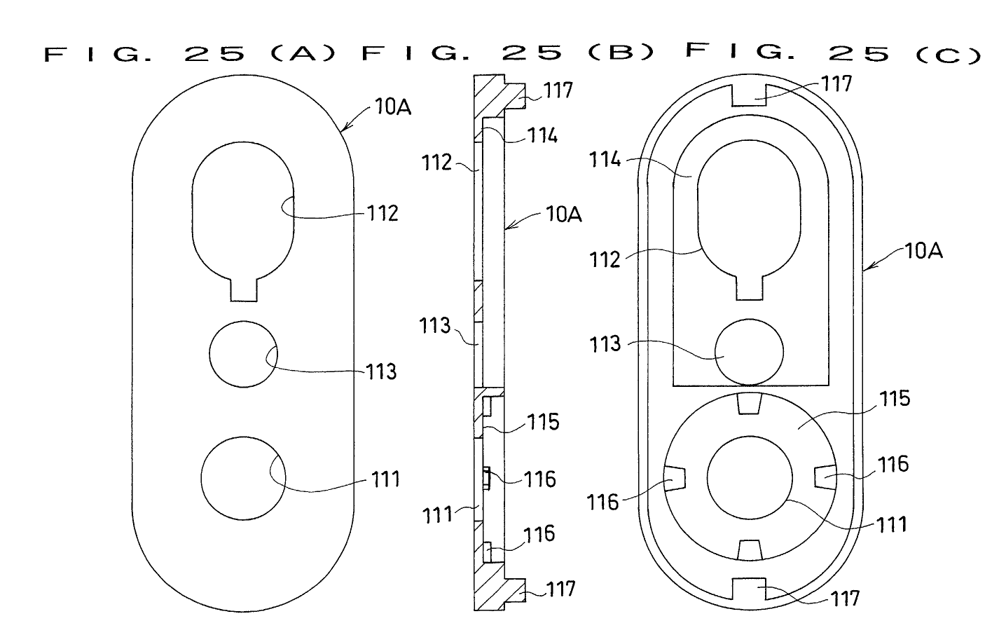

As shown in FIG. 24 and FIG. 25, the hinge body 10A, buried in the open frame K, will be perforated to provide a cam insertion hole 111 in which to insert part of the adjusting cam 10D in a rotatable way, a metal adjusting hole 112 in an oval shape, and a mounting hole 13 in which to insert fastening screw, etc. at about the central part of the hinge body 10A, while on the back face side of the hige body 10A it will form a depression 115 in the shape of a counterbore at the peripheral position of the cam insertion hole 111, form fastening claws 116, 116 in a convex shape at regular intervals along the inner circumferential direction of this depression 115, at 4 positions at 90 intervals as illustrated, for example, and further form in projection, at both ends in the longitudinal direction on the back face of the hinge body 10A, fastening projections 117, 117 for positioning and fastening the body cover 10F.

Moreover, the depression 115 in the shape of a counterbore will be realized as a round depression enabling to insert the disc-shaped collar element of the adjusting cam 10D inside, with a depth preferably about equal to the thickness of the disc-shaped collar element of adjusting cam 10D.

Furthermore, the metal adjusting hole 112 will be a slit, and its length will be determined in such a way that the spindle inserting position is adjustable in the direction of breadth of the door D.

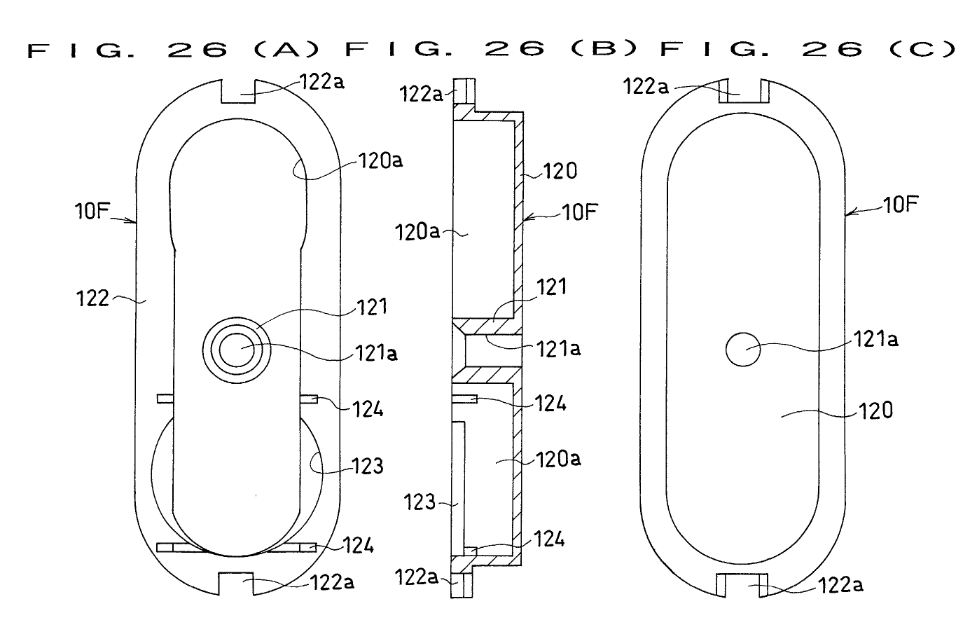

The body cover 10F integrated with the hinge body 10A along the back face side of the latter has an oval shape about equal to the shape of the hinge body 10A, integrally forms a box 120 swelling on one side face, forms in projection a boss 121 having a set screw hole 121a perforated at about the center position of the depression 120a of this box 120, forms a peripheral collar 122 along the outer circumference of the box 120, and forms, at both ends in the longitudinal direction of this peripheral collar 122, notches 122a, 122a to be engaged with the fastening projections 117, 117 of the hinge body 10A for integrally fixing (the body cover 10F) with the hinge body 10A by caulking, etc., as shown in FIG. 26.

Still more, on this body cover 10F will be formed a shallow depression 123, at one end side of the depression 120a of the oval box 120. In this shallow depression 123 will be formed two spring insertion grooves 124, 124 in parallel to the tangential direction of the shallow depression 123, in which to insert the adjusting cam 10D, more specifically the disc-shaped collar 140 of the adjusting cam 10D, depressible against a spring.

And, in these spring insertion grooves 124, 124 will be inserted bar-shaped springs 125, 125 made of piano wire, etc. respectively, so as to support the back face side of the disc-shaped collar 140 of the adjusting cam 10D, and press it to the inner surface side of the shallow depression 123.

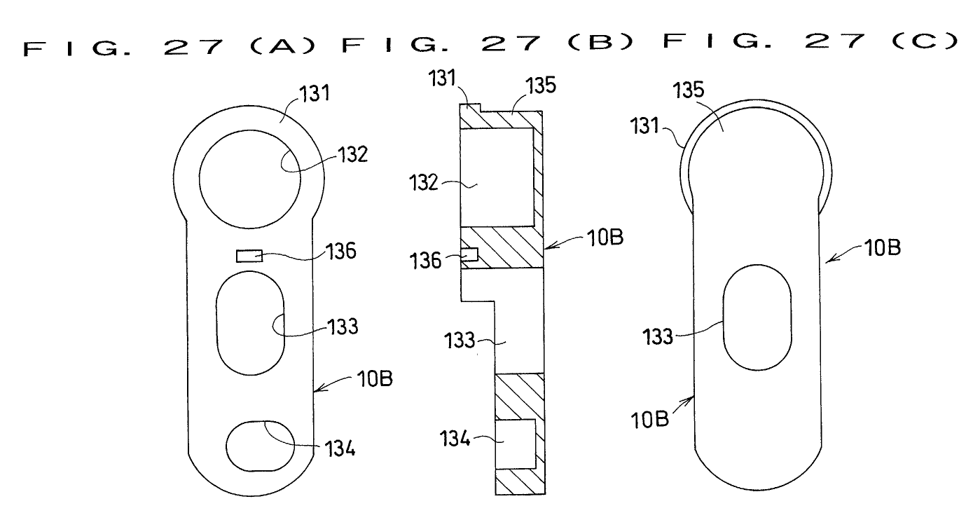

The slide base 10B will be formed in an oval shape, in a way to be slidably inserted in the oval-shaped box 120 of the body cover 10F, as shown in FIG. 24 and FIG. 27.

In the body 130 of this slide base 10B will be formed, inside the metal insertion barrel 135 formed at one end, a metal insertion hole 132 with a bed, a collar 131 at outer circumference of the metal insertion barrel 135, a slit 133 provided at the center along the direction of slit of the body 130, and a slit 134 worked at the other end in the direction orthogonal to the longitudinal direction of the body 130.

This will make it possible for the slide base 10B to slide, in the body cover 10F along the longitudinal direction thereof, by an amount equal to the amount of eccentricity in the longitudinal direction while retracting the amount of eccentricity in the transversal direction of the adjusting cam 10D, when the eccentric shaft of the adjusting cam 10D is inserted in the slit 134 and turn off the center of the adjusting cam 10D with the rotation of the adjusting cam 10D.

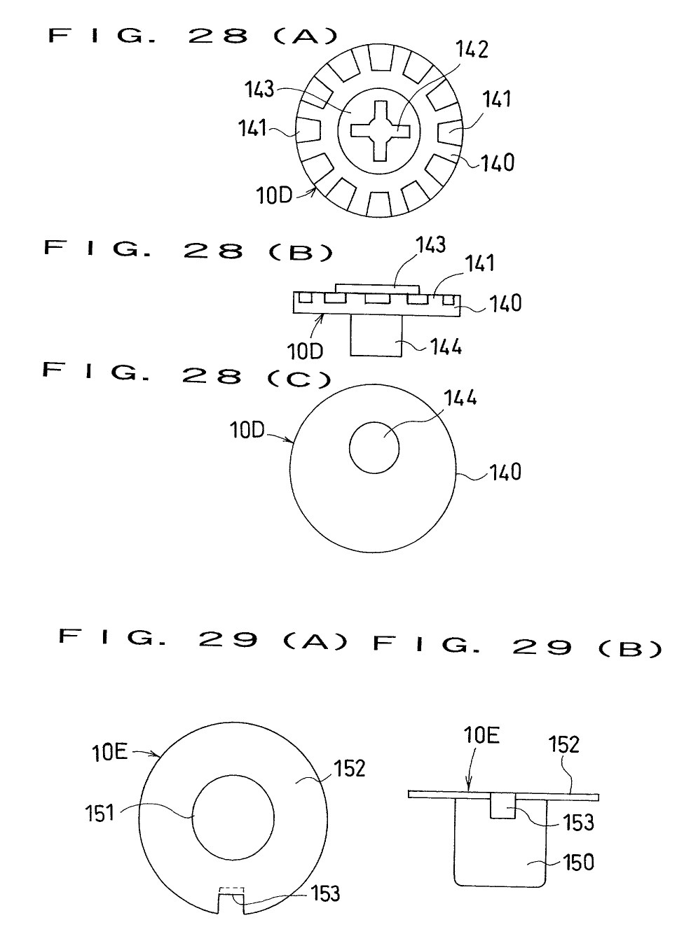

The adjusting cam 10D will form a disc-shaped operating element 143 in projection, at the central part on one end side of the disc-shaped collar 140 and in a diameter smaller than that of the disc-shaped element, in a way to be rotatably inserted in the cam insertion hole 111 on the hinge body 10A side, form, on the surface side of this disc-shaped collar 140 constituting the body unit of the adjusting cam D, fastening claws 141, 141 disposed alternately in concavity and convexity at predetermined intervals or angles along the circumferential direction in a way to be engaged with either one of the fastening claws 116 on the hinge body side, further form a rotatable fastening groove 142 for fastening and turning a plus screwdriver, etc. inside the operating element 143, and also form, on the back face side of disc-shaped collar 140, an eccentric shaft 144 in projection with an eccentricity of a predetermined distance against the center of the disc-shaped collar 140, as shown in FIG. 24 and FIG. 28.

This will make it possible for the slide base 10B, in which is inserted the eccentric shaft 144, to move in the body cover 10F along the longitudinal direction thereof, according to the amount of eccentricity of the eccentric shaft 144, when the adjusting cam 10D rotates.

Yet more, the adjusting cam 10D will be realized in a way to be supported by the springs 125, 125 inserted in the spring insertion groove 124 and pressed by spring pressure toward the hinge body side, when it is inserted in the box 120 of the body cover 10F, at both ends on the back face of the disc-shaped collar 140 of the adjusting cam 10D, and to be rotatable in either the clockwise or counterclockwise directions of the adjusting cam 10D, by loosening the springs 125, 125 and releasing the fastening between the fastening claws 116 and 141, when the adjusting cam 10D is further pressed in a way to be pushed into the body cover.

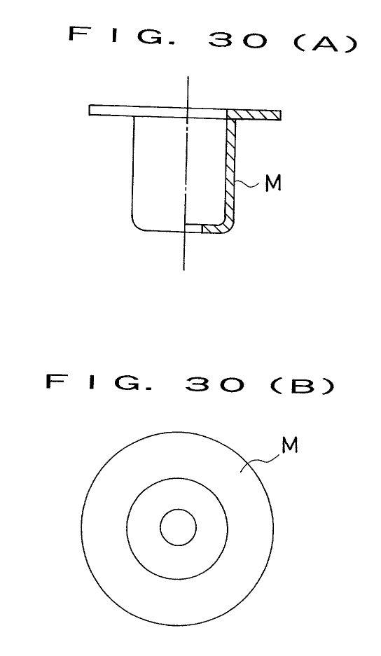

The metal 10E will form, inside a cylinder-shaped spindle insertion barrel 150 enabling insertion of the spindle 2, a spindle insertion hole 151, integrally form a collar 152 on one end face side of this spindle insertion hole 150, and form a tongue-shape fastening element 153 by notching part of the collar 152, as shown in FIG. 24 and FIG. 29, to thereby be fastened to a fastening groove 136 formed in the metal insertion barrel 135, for protection against turning of the metal 10E.

The assembling of the second modified example of hinge body unit in this second embodiment will be explained below.

First, insert the slide base 10B in the box 120 of the body cover 10F, insert the springs 125, 125 in the spring insertion holes 124, 124 respectively, and then place the adjusting cam 10D on the slide base 10B by inserting the eccentric shaft 144 in the slit 134 of this slide base 10B.

Next, dispose the hinge body 10A in a way to cover over this body cover 10F. At that time, insert the disc-shaped collar 140 of the adjusting cam 10D in the shallow depression 123 of the body cover 10F, and insert the operating element 143 in the cam insertion hole 111.

Next, integrate the hinge body 10A and the body cover 10F by caulking either one of the fastening projection 117 or the peripheral collar 122 provided with the notch 122a.

And, assemble the hinge body unit B by inserting the metal 10E in the metal insertion hole 132 from the outside of the hinge body 10A through the metal adjusting hole 112, and fixing it there.

In this second modified example of hinge body unit in the second embodiment, turn the adjusting cam 10D in the clockwise direction by means of a screwdriver, etc., when adjusting the spindle 2 inserting position along the direction of breadth of the door D. In that case, it is necessary to release the fastening between the fastening claw 141 of the adjusting cam 10D and the fastening claw 116 of the hinge body, because these fastening claws 141, 116 are mutually fastened and unrotatable.

Therefore, to release the fastening between these fastening claws 141, 116, press the adjusting cam 10D in a way to push it into the body cover, and the spring 125 will be loosened, the adjusting cam 10D will be pushed into the body cover, and the fastening between these fastening claws 141, 116 will be released to enable the adjusting cam 10D to turn freely, thus making it possible to perform adjustment by turning the adjusting cam 10D in either the clockwise or counterclockwise directions.

The fastening claw 116 formed on the hinge body 10A and the fastening claw 141 formed on the adjusting cam 10D may also take the shape of a sawtooth. In that case, the fastening claws 141, 116 act as unidirectional clutches, and the adjusting cam 10D turns in the clockwise direction only but is unable to turn in the counterclockwise direction because the fastening claws 141, 116 are fastened to each other. For turning in the counterclockwise direction, the adjusting cam 10D is pressed in a way to be pushed into the body cover, and the spring 125 will be loosened, the adjusting cam 10D will be pushed into the body cover, and the fastening between the fastening claws 141, 116 will be released to enable the adjusting cam 10D to turn freely, thus making it possible to perform adjustment by turning the adjusting cam 10D in the counterclockwise direction in this state.

The hinge according to the present invention has so far be explained based on a plurality of embodiments and their modified examples. However, the present invention is not restricted to the constructions described in said embodiments, but its construction may be modified as required within the range not deviated from its purpose, by such means as combining the constructions described in the respective embodiments and their modified examples as required, etc.

Moreover, the hinge body may be used in the form of said embodiments for both the top and the bottom parts of the door, but it is also possible to adopt one of said embodiments for the open frame K at the bottom and adopt a metal M of simple construction realized by simply fitting a spindle, as shown in FIG. 30, for the open frame K at the top. In that case, the adjustment of mounting of the door will be made at the hinge body unit installed on the open frame side at the bottom.

What is claimed is:

1. A hinge characterized in that it is comprised of a hinge spindle unit, buried flush with the top and bottom lines on the fixed end of the door and disposed in a way to allow protrusion and retraction of the spindle, and a hinge body unit, buried at a position facing the hinge spindle unit of the open frame and in which is inserted the protruding spindle, and supporting the door in a way that it can both open and close.

2. A hinge as defined in claim 1, wherein the hinge spindle unit is comprised of a spindle case body, a spindle inserted in the spindle case body in a way to be locked and protrude and retract under the urging force of a spring, and a stopper holding the spindle in a state retracted in the spindle case body.

3. A hinge as defined in claim 1, wherein the hinge spindle unit is comprised of a spindle case body, a spindle inserted in the spindle case body in a way to be locked and forming a rack gear biting with a pinion disposed in the spindle case body and capable of protruding and retracting by turning said pinion, and a stopper holding the spindle in prescribed position.

4. A hinge as defined in claim 1, 2 or 3, wherein the hinge body unit is comprised of a hinge body provided with a boss in which to insert a spindle, and a cam slidably supported in the hinge body and retracting the spindle.

5. A hinge as defined in claim 1, 2, 3 or 4, wherein the hinge body unit is comprised of a hinge body buried and fixed at a position facing the hinge spindle unit of the open frame, and a slide base, disposed slidably against the hinge body and forming a spindle insertion hole in a way to be fixed at any desired position on the hinge body.
